(19) United States
(12) Patent Application Publication
(10) Pub. No.: US 2011/0231269 A1
(43) Pub. Date: Sep. 22, 2011

(54) Method for Recipient Orientated Financial Services

(76) Inventor: Michael Joseph Mulhall, Ottawa (CA)

(21) Appl. No.: 12/854,923

(22) Filed: Aug. 12, 2010

Related U.S. Application Data
(60) Provisional application No. 61/315,050, filed on Mar. 18, 2010.

(51) Int. Cl. G06Q 30/00; G06K 19/06; G06Q 40/00

(52) U.S. Cl. 705/17; 235/375; 235/494; 705/26.1

(57) ABSTRACT

A method allowing a first person to provide a “virtual” gift to a second party is disclosed, referred to as a “credit gifting” system, wherein the first person accesses an application allowing predetermined aspects of the gift, such as the retailer, store, product type etc to predetermined whilst adding personal messages etc. The second person receives a credit towards the purchase of the gift, the credit being redeemable at the defined retailer or store for any wares/services or only those identified by first person. If the credit so gifted is not redeemed within predetermined time the first person is re-credited. In another embodiment the second person is able to select the retailer or store to redeem from or if unable to redeem themselves allocate a proxy. Accordingly the method overcomes drawbacks of current “captive” gift cards and pre-paid gift cards whilst also offering enhanced registry services etc.

### FIELD OF THE INVENTION

This invention relates to providing a “credit” for a recipient to purchase a gift, product or service and more specifically to providing the credit electronically with improved demographic acquisition properties.

### BACKGROUND OF THE INVENTION

The giving of a gift using credit for the purchase of a gift by an individual, a family, an organization, a business, or other group is a common everyday occurrence to us. The giftor, the one giving the gift, typically has suffered anxiety or stress associated with selecting and purchasing the appropriate gift for the giftee, the one receiving the gift, such that it is not only personal to the giftee but says something about the giftor, is appropriate, is something they believe the giftee wants and is not going to be disposed off, hidden away or re-gifted to another giftee. The advent of gift cards by stores and other organizations relieved a measure of this stress in that now the giftor relinquished some portions of the gift giving process by allowing the giftee to select the gift they wanted within the value of the gift given or by adding to it to buy something more expensive. However, whilst generally this removed the “unwanted gift” aspect of gift giving it also removed the personal selection of the gift by the giftor for the giftee. It still burdens the giftor with how and where the gift card is purchased, paid for, and sent to the giftee.

The advent of the Internet and electronic commerce on the Internet has not fundamentally changed either the traditional gift giving approach or that based upon gift cards, sometimes called gift certificates. Essentially the Internet allows the giftor to go online, browse a wider selection of stores and products than they would traditionally have been able to physically access and chose a gift for the giftee which is then charged to one of their financial instruments, such as for example their PayPal™ account or a credit card, before being dispatched by the retailer to the giftee perhaps with a simple personal message from the giftor. Similarly with gift cards the Internet has allowed giftors to access a wider range of gift cards and have these delivered to the giftee who then uses them in exactly the same manner, namely physically takes the gift card to the store and redeems it against an item they select. Further, the Internet has opened new channels of business such as Amazon™, iTunes™, etc which have no physical retail outlets and in some instances even no warehousing or distribution infrastructure as everything is outsourced. However, not all stores through factors including but not limited to size, resources, etc are able to issue gift cards.

Accordingly, when considering gift cards these are generally associated with a particular retailer and hence the giftor selects for example a Sears™ gift card, an iTunes™ gift card, an American Eagle™ gift card and that is sent to the giftee. If the giftor purchases the gift card at a store or online and has it mailed to them prior to sending it to the giftee then the only information that the retailer may have is that it was sold to the giftor, and the giftor must still send the gift card to the giftee. In many instances the retailer does not even have any information on the giftee or giftor as unless the giftor or giftee redeems the gift card in conjunction with another financial instrument that provides the retailer with information relating to themselves, such as a bank debit card, a credit card etc, then the retailer has minimal demographic information on the use of their gift cards and does not gain any information allowing them to build a picture of either the giftor or giftee's purchasing habits that they can use in targeted advertising at a subsequent date. Further, whilst a gift card may have been sent to the giftee by the retailer at the request of the giftor without the associated financial instrument outlined above there is nothing to tell the retailer that is was actually used by the giftee.

Retailers have a vested interest in understanding the demographics of their customer base as well as the purchasing habits of customers both as a whole and individually. With the former these demographics provide the overall structure to their product lines, branding, etc whilst the latter allows them to provide targeted advertising or more personal advertising and/or communications. In order to achieve this it would be beneficial to provide a closer association between the activity of purchasing a gift card, the recipient of the gift card and their transactions with that gift card. Additionally hundreds of millions of dollars of gift cards are lost, unclaimed or are rescinded each year, the latter where the expiry date of the gift card has expired before the giftee uses all of the credit resulting in consumer dissatisfaction and even Government intervention and regulations, such as outlined below in respect of United States CARD Act.

Further, the giftor may be resident in another part of the same country as the giftee, resident within another country, or wish to give the giftee a gift that they can utilize in combination with a planned vacation, business trip, etc of the giftee. In such instances the giftor may not be able to establish a retailer to provide the gift card in association with wares or services they would like to give and may resort to sending simply a financial gift, such as money, cheque, travelers cheques etc, and thereby they or the giftee may consider this impersonal. This gift also provides nothing to the benefit of the retailer in improving their demographic or personal information. Additionally such restrictions impact consumers views of so-called “captive” gift cards, i.e. those associated with a single retailer. Such consumer confidence is further compromised by failures of retailers, for example approximately US $100 million in loaded gift card value were compromised when retailers such as Sharper Image™ and Linens 'n Things™ failed in 2008. Legal adjustments in the United States under Title IV of the Credit Card Accountability and Responsibility and Disclosure (CARD) Act to make 5 years the minimum “life” of a gift card are expected to go into force in late 2010 to address consumer complaints and confidence in gift cards, both “captive” and “general purpose”, these later cards being pre-paid debit cards.

Research from financial advisory firm TowerGroup (http://www.towergroup.com/research/news/news.htm?newsId=5500) projected that total gift card market would fall from US $91 billion in 2008 to US $87 billion in 2009, the second straight yearly decline. Store gift card sales, i.e. “captive” were projected to fall from US $63 billion to US $58 billion, while “general purpose” pre-paid gift cards were projected to show a modest 3% increase to US $29 billion from US $28 billion last year. In fact, sales of general purpose prepaid gift cards, such as those offered by Mastercard™ or Visa™, have increased in revenue for the last five years thereby further eroding the personal information that may be acquired and utilized by retailers.

It is, therefore, desirable to provide the giftee with an ability to receive a gift credit from the giftor and allow them in some circumstances to change the retailer to which the gift credit relates or where it has been associated with a particular store of a retailer to change the store for example from a local store to another perhaps specialist store that the giftee is willing to visit to acquire the item they wish to purchase.

Accordingly it is an intention of embodiments of the invention to provide an increased level of personal association of the gift card between the giftor and giftee whilst also providing retailers with increased demographic and customer specific information and address drawbacks of current “captive” and pre-paid gift cards in these areas. In order to differentiate the invention and embodiments of the invention from such “captive” and pre-paid gift cards as well as debit cards, credit cards etc we refer to the approach as “credit gifting” throughout this application.

### SUMMARY OF THE INVENTION

It is an object of the present invention to obviate or mitigate at least one disadvantage of the prior art.

In accordance with an embodiment of the invention there is provided a method comprising providing a database accessible to users of a computer network, the database comprising a plurality of entries relating to providers, a plurality of entries relating to items provided by the providers, a plurality of entries relating to users wishing to give a gift, and a plurality of entries relating to users for whom a gift has been requested and receiving from a user first data, the first data comprising a first data portion relating to aspects of the user, a second data portion relating to aspects of a recipient, and a third data portion relating to an entry within the database, the entry being one of the entries relating to at least one of wares and services.

The method further comprising receiving from the user second data relating to a financial instrument, charging against the financial instrument a charge determined in dependence upon at least an entry of a financial value by the user; and upon verification that the charge against the financial instrument has been accepted at least one of sending to the recipient a first indication that a credit has been (gifted) made, the first indication comprising at least one an aspect of the user, an aspect of the recipient, the financial value, and redeem information relating to the entry within the database provided by the user, and sending to the provider relating to the entry provided by the user a second indication that a credit has been gifted, the second indication comprising at least one an aspect of the recipient, the financial value, and redeem information relating to the entry within the database provided by the user.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of a method of giving a gift card according to the prior art;

FIG. 2 is a schematic of a method of giving a gift card with an Internet based activity by the giftor according to the prior art;

FIG. 3 is a schematic of credit gifting according to an embodiment of the invention wherein the credit gifting system advises the giftee and retailer of the gift credit;

FIG. 4 is a schematic of credit gifting according to an embodiment of the invention wherein the retailer advises the giftee of the gift credit based upon information provided by the credit gifting system;

FIG. 5 is a schematic of credit gifting according to an embodiment of the invention wherein the giftee is advised of the gift credit based upon information provided by the credit gifting system and can select the store from which to redeem the gift credit;

FIG. 6 is a schematic of credit gifting according to an embodiment of the invention wherein the giftee is advised of the gift credit based upon information provided by the credit gifting system and can select both the retailer and the store from which to redeem the gift credit;

FIG. 7 is a flow diagram according to an embodiment of the invention;

FIG. 8 is schematic of credit gifting according to an embodiment of the invention wherein the giftee is advised of the gift credit based upon information provided by the credit gifting system and can select the retailer and store from which to redeem the gift credit but subsequently cannot redeem and elect a third party to redeem it; and

FIG. 9 is a schematic of credit gifting according to an embodiment of the invention wherein the giftor elects to choose from a lottery as the gift to the giftee.

### DETAILED DESCRIPTION

The present invention is directed to providing an increased level of personal association of a gift card exchanged between a giftor and giftee whilst also providing retailers with increased demographic and customer specific information and address drawbacks of prior art approaches. Accordingly it is an object of the invention to provide a more convenient way for a giftor to provide a giftee a credit for a gift in lieu of the gift itself, and which provides additional advantage to giftor, giftee, and retailers.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements. Within these embodiments reference will be made to terms which are indented to simplify the descriptions, including for example giftor relating to the person making the gift, giftee relating to the person receiving the gift, gift credit relating to a credit provided by the giftor to the giftee which can be redeemed by the giftee from a retailer.

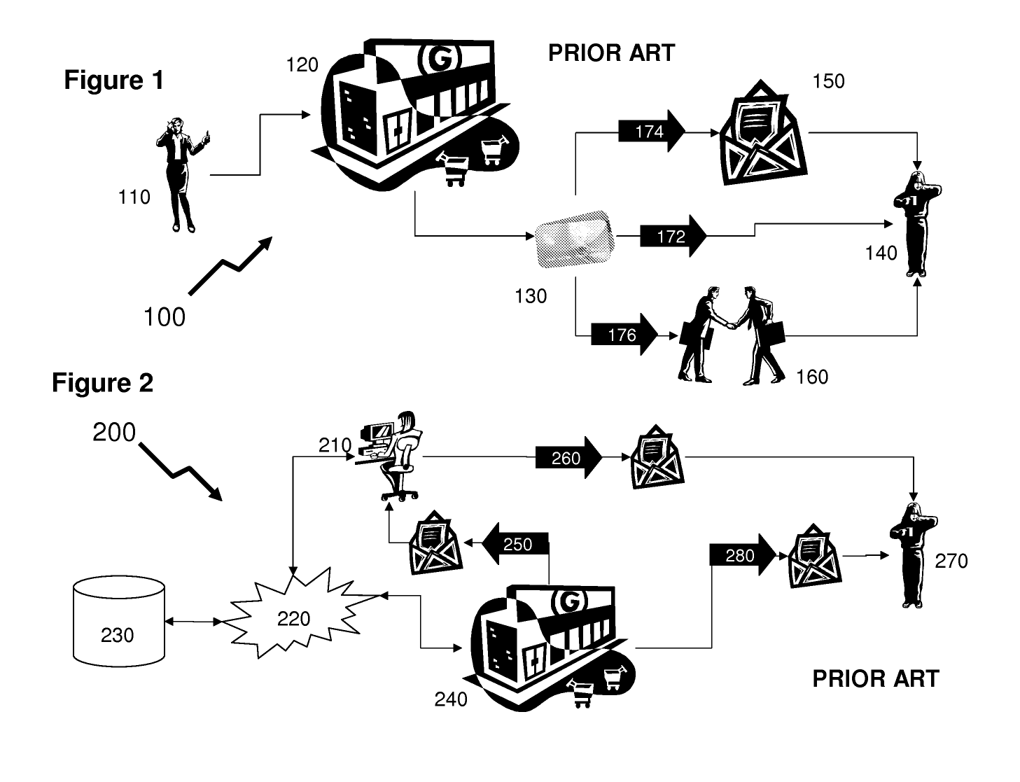

FIG. 1 depicts a schematic 100 of a method of giving a gift card according to the prior art. As shown a giftor 110 wishes to purchase a gift card for giftee 140. As such the giftor 110 visits the retailer 120 that they have chosen to purchase a gift card from and purchases the gift card, not shown for clarity, and departs with gift card 130. They are then presented with the problem of delivering the gift card 130 to the giftee 140. If they live locally to the giftee 140 or are meeting them at a convenient point in time in the future then they may deliver the gift card 130 personally in first process 172. Alternatively they may decide to give it to another individual, for example another family member or friend, to give to the giftee 140 in their behalf in second process 176. If neither of these options is feasible then the giftor 110 would mail the gift card 130 to the giftee 140 in third process 174.

It would be evident that the retailer 120 has little information relating to the gift card 130 unless the giftor 110 uses a credit card or other financial instrument providing their identity or giftee 140 in using the gift card 130 similarly uses a financial instrument providing their identity. Without this information the retailer simply knows that a gift card 130 was bought by a first individual and redeemed at some later point in time by the same or another individual at the same or other retail establishment for specific goods. They cannot assign any demographic information or customer specific information to the purchase or purchases made with the gift card 130.

FIG. 2 depicts a schematic 200 of a method of giving a gift card according to the prior art wherein the giftor 210 is for example unable to get to the retailer 240 or wishes to purchase the gift card, not shown, outside of retailer opening hours. As shown the giftor 210 wishes to purchase a gift card for giftee 270. As such the giftor 210 visits the website of the retailer 240 by accessing the company website server 230 though a computer network 220 such as the Internet. When they have chosen to purchase a gift card from the retailer 240 they enter some personal details in respect of themselves, provide a financial payment and select a delivery address for the gift card. Accordingly the retailer 240 either sends the gift card in first process 250 to the giftor 210 who then mails it in second process 260 to giftee 270, or mails the gift card directly to the giftee 270 in third process 280.

It would be evident that the retailer 240 now has some additional information relating to the gift card as the giftor 210 used a credit card or other financial instrument providing their identity to make the purchase. If the giftor 210 elected to have the gift card delivered directly to the giftee 270 then the retailer now knows a name and address to which the gift card was delivered. However, if the giftor 210 elects to have the gift card delivered to them and then sends it or gives it to the giftee 270 then unless the giftee 270 uses a financial instrument providing their identity to augment their purchase the retailer has little information on the actual correlation between the gift card and giftee 270. They therefore cannot assign significant demographic information or customer specific information to the purchase or purchases made with the gift card.

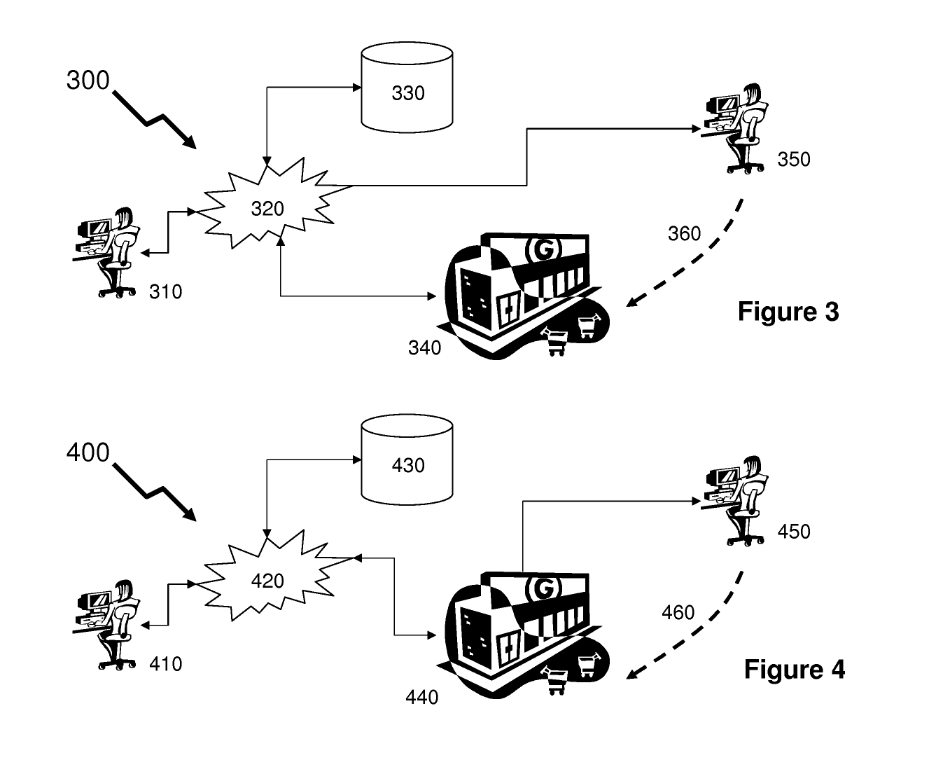

Referring to FIG. 3 there is depicted a schematic 300 of the credit gifting method according to an embodiment of the invention wherein a credit gifting system 330 advises a giftee 350 and a retailer 340 of the existence of a gift credit. Accordingly as shown a giftor 310 accesses the credit gifting system 330 through a computer network 320, such as the Internet. In doing so they are presented with a series of prompts and requests for information which may be contained within a single web page or a plurality of web pages as would be evident to one skilled in the art. As such the giftor 310 provides information relating to them including for example their name, address, age, credit card information or other information relating to a means of paying for the gift credit, i.e. a PayPal™ account and password. At this point the credit gifting system 330 also seeks authorization from the giftor 310 in respect of using the financial instrument, i.e. credit card, PayPal™ etc. This authorization also includes approval to purchase the gift credit in whatever currency the gift credit is purchased in. information may be associated with a user profile created by the giftor at that point in time or previously. They then access the list of member retailers who are part of credit gifting system, which may be via one of many methods known to those skilled in the art by selecting a geographic location (e.g. Tampa Bay, Washington, Ottawa, Paris, Berlin etc), an area of interest (i.e. hockey, NASCAR, clothing etc), or list of retailers who the giftor 310 has previously used or prefers.

Having worked through the selection process the giftor 310 has now selected a retailer and a store 340 associated with the retailer which meets a predetermined condition in respect of the giftee 350 to whom they wish to send the gift credit. For example the store 340 may be close to the home or office of giftee 350, be specific in choice of goods and services to meet an interest of giftee 350, be associated with a location giftee 350 will be in at a subsequent point in time such as traveling for pleasure or on business. The giftor 310 then enters information relating to the giftee 350 such as a name, electronic mailing address and other details they wish to release. It would be evident for example that the giftor 310 may have to provide some information as a default requirement whilst other information is optional and the giftor 310 is told that this allows the credit gifting system 330 to subsequently provide other options to the giftor 310 when they select a gift credit another time or send special offers to the giftee 350.

Once completed the credit gifting system 330 sends an electronic message to giftee 350 notifying them that giftor 310 has purchased them a gift credit at retailer 340 that they may collect and use. Subsequently the giftee 350 goes to retailer 340 in process 360 and obtains the gift credit from the customer service counter on providing valid confirmatory identification. This may for example be in the form determined by the retailer such as a traditional “captive” gift card or another instrument that they wish to employ. For example to increase the giftee 350 view of the process the gift credit may be provided in a manner personalized to them and/or the giftor 310. For example the gift card may be printed at that point with “Dear Fred, Knowing your love of rock climbing thought you'd find something here at Mountain Equipment, Love Jane”, wherein “Fred” is associated with the giftee 350, “Jane” with the giftor 310 and “Mountain Equipment” with retailer 340. Alternatively, the gift credit may be very specific such as “Dear Fred, Knowing your love of rock climbing I thought you'd like a Petzl Meteor III helmet, Love Jane.” It would be evident that many options exist to provide the gift credit to the giftee 350 as a physical object to take to the retailer 340.

Alternatively according to the technical capabilities of the retailer 340 the giftor 350 may be provided with an electronic bar code or any other type of secure recognition that is scanned at the checkouts that debits the value of the purchase from the gift credited to them. Alternatively, the credit gifting system 330 provides only a message to the giftee 350, such as “Dear Fred, Knowing your love of rock climbing there is a credit available for you at Mountain Equipment Co-Op for a Petzl Meteor III helmet, your password to redeem this is Yo Freddie, Love Jane.” Evident to one skilled in the art is that the password may be selected by the giftee 310 for the giftor 350 or established alternatively by the retailer 340/credit gifting system 330. It would evident to one skilled in the art that the credit gifting system 330 within this embodiment is able to provide demographic information to the retailer 340 that associates particular products and services to the giftee 350 but also the giftor 310. The retailer 340 is then able to use this information in its planning as well as leveraging this in respect of more specifically targeted advertising, such as for example “Hi Fred, last month you bought a Petzl helmet from us here at Mountain Equipment, this month we have a special on Petzl equipment.”

Within the foregoing description of a credit gifting method according to an embodiment of the invention as depicted by schematic 300 it would be apparent to one skilled in the art that in each communication described or implicitly required to perform an action that additional communications between credit gifting system 330, retailer 340, giftor 310 and giftee 350 may be provided including but not limited to a receipt indicating the purchase of the gift credit for giftee 350, receipt from retailer 340 to credit gifting system 330, and confirmation receipt from credit gifting system 330 to giftor 310 when giftee 350 redeems.

Retailers, such as retailer 340, are members of the credit gifting system 330 and have agreed to accept the terms and conditions of the credit gifting system 330. These retailers would be advertised and listed within the credit gifting system 330 allowing the giftor 310/giftee 350 to choose them as the retailer to purchase the gift from within the credit gifting system. Optionally, these retailers may direct those accessing their own websites through the credit gifting system 330 to purchase a gift credit in addition to or in replacement of their own online purchasing to reduce operating costs and increase their demographic information obtained through the credit gifting system 330. Retailers which are members of the credit gifting system 330 pay a membership fee which may be a fixed fee or a prorated fee based upon the volume of purchases made through the credit gifting system.

Referring to FIG. 4 there is a schematic 400 of credit gifting according to an embodiment of the invention. Accordingly as shown a giftor 410 accesses the credit gifting system 430 through a computer network 420, such as the Internet. In doing so they are presented with a series of prompts and requests for information which may be contained within a single web page or a plurality of web pages as would be evident to one skilled in the art. As such the giftor 410 provides information relating to themselves including for example their name, address, age, credit card information or other information relating to a means of paying for the gift credit, i.e. a PayPal™ account and password. At this point the credit gifting system 430 also seeks authorization from the giftor 410 in respect of using the financial instrument, i.e. credit card, PayPal™ etc. This authorization also includes approval to purchase the gift credit in whatever currency the gift credit is purchased in. This information may be associated with a user profile created by the giftor at that point in time or previously. They then access the list of member retailers who are part of credit gifting system, which may be via one of many methods known to those skilled in the art by selecting a geographic location (e.g. Tampa Bay, Washington, Ottawa, Paris, Berlin etc), an area of interest (i.e. hockey, NASCAR, clothing etc), or list of retailers giftor 410 has previously used or prefers.

Having worked through the selection process the giftor 410 has now selected a retailer and a store 440 associated with the retailer which meets a predetermined condition in respect of the giftee 450 to whom they wish to send the gift credit. For example the store 440 may be close to the home or office of giftee 450, be specific in choice of goods and services to meet an interest of giftee 450, be associated with a location giftee 450 will be in at a subsequent point in time such as traveling for pleasure or on business. The giftor 410 then enters information relating to the giftee 450 such as a name, electronic mailing address and other details they wish to release. It would be evident for example that the giftor 410 may have to provide some information as a default requirement whilst other information is optional and the giftor 410 is told that this allows the credit gifting system 430 to subsequently provide other options to the giftor 410 when they select a gift credit another time or send special offers to the giftee 450.

Once completed the credit gifting system 430 sends an electronic message to the retailer 440 notifying them that giftor 410 has purchased a gift credit for their store, for giftee 450. The retailer then issues to giftee 450 an electronic message indicating that they have a gift credit at retailer 440 that they may collect and use. This electronic message may for example say “Dear Fred, Knowing your love of rock climbing Jane thought you might find something here at Mountain Equipment for your birthday” wherein “Fred” is associated with the giftee 450, “Jane” with the giftor 410 and “Mountain Equipment” with retailer 440. Associated with the electronic message sent by retailer 440 to giftee 450 may be advertising such as for example associated with the retailer 440, associated with the wares/services that giftor 410 used in selecting the retailer 440, or giftor 450 as they are known to retailer 440 in their databases and information is selected based upon their demographic or purchasing history.

It would be evident that many options exist to provide credit as a gift to the giftee 450. Subsequently the giftee 450 goes to retailer 440 in process 460 and obtains the gift credit from the customer service counter on providing valid confirmatory identification. This may for example be in the form determined by the retailer such as a traditional “captive” gift card or another instrument that they wish to employ. For example to increase the giftee 450 approval of the process the gift credit may be provided in a manner personalized to them and/or the giftor 410. For example the gift card may again be printed at that point with “Dear Fred, Happy Birthday, From Jane . . . . Knowing your love of rock climbing Jane thought you might find something here at Mountain Equipment for your birthday”. The gift credit may be provided with an electronic bar code or any other type of secure recognition. Additionally at this point the retailer 440 may provide additional advertising or special offers to the giftor 450. For example, such special offers being associated with the wares/services that giftor 410 used in selecting the retailer 440, or giftor 450 as they are known to retailer 440 in their databases and information is selected based upon their demographic or purchasing history. Similarly the special offer may to encourage use of the credit gifting system as the retailer 440 has found that for every $1 spent from the gift credit the giftor 450 spends another $1 whereas using “captive” gift cards that additional spending is $0.35 for example per $1 on the gift card used.

Within the foregoing description of a gift crediting method according to an embodiment of the invention as depicted by schematic 400 it would be apparent to one skilled in the art that in each communication described or implicitly required to perform an action that additional communications between credit gifting system 430, retailer 440, giftor 410 and giftee 450 may be provided including but not limited to a receipt indicating the purchase of the gift credit for giftee 450, receipt from retailer 440 to credit gifting system 430, and confirmation receipt from credit gifting system 430 to giftor 410 when giftee 450 redeems.

It would be evident to one skilled in the art that the credit gifting system, such as that described in respect of credit gifting systems 330 and 430 in FIGS. 3 and 4 respectfully supra, is a software application or group of software applications that provide the multiple functions required, including but not limited to establishing the catalog of recommended retailers, locations of all outlets of recommended retailers, catalogs of items available for purchase with geographic restrictions/limitations if appropriate, browsing and “cart” features for giftor to select and store purchases, “check out” for giftor to purchase gift credit(s), communications to advise retailer/giftee of the gift credit purchases, clearing financial transactions, etc.

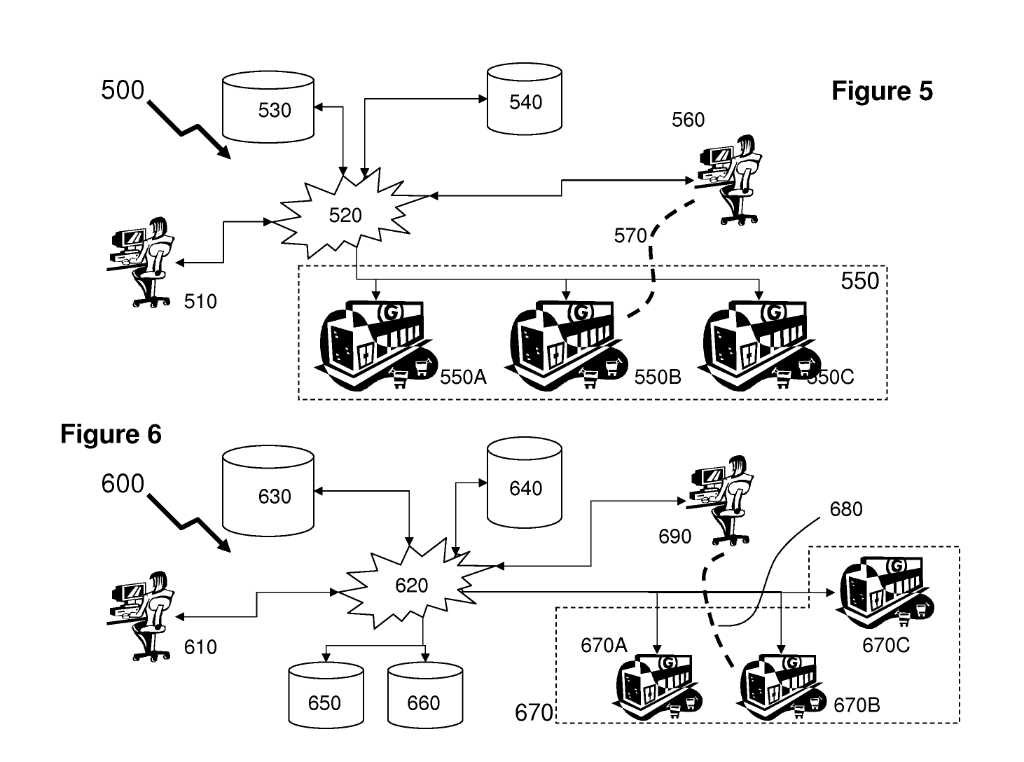

Now referring to FIG. 5 there is shown a schematic 500 of credit gifting according to an embodiment of the invention wherein the giftee 560 is advised of the gift credit based upon information provided by the credit gifting system 530 and can select the store from which to redeem the gift credit. Accordingly as shown a giftor 510 accesses the credit gifting system 530 through a computer network 520, such as the Internet. In doing so they are presented with a series of prompts and requests for information which may be contained within a single web page or a plurality of web pages as would be evident to one skilled in the art. As such the giftor 510 provides information relating to themselves including for example their name, address, age, credit card information or other information relating to a means of paying for the gift credit, i.e. a PayPal™ account and password. At this point the credit gifting system 530 also seeks authorization from the giftor 510 in respect of using the financial instrument, i.e. credit card, PayPal™ etc. This authorization also includes approval to purchase the gift credit in whatever currency the gift credit is purchased in. This information may be associated with a user profile created by the giftor at that point in time or previously. They then access the list of member retailers who are part of the credit gifting system 530, which may be via one of many methods known to those skilled in the art by selecting a geographic location (e.g. Tampa Bay, Washington, Ottawa, Paris, Berlin etc), an area of interest (i.e. hockey, NASCAR, clothing etc), or list of retailers that giftor 510 has previously used or prefers.

Having worked through the selection process the giftor 510 has now selected a retailer chain 550, comprising first through third stores 550A through 550C respectively, which meets a predetermined condition in respect of the giftee 560 to whom they wish to send the gift credit. For example the retailer chain 550 may be unique to the area around the home or office of giftee 560, be specific in choice of goods and services to meet an interest of giftee 550, be associated with a location giftee 560 will be in at a subsequent point in time such as traveling for pleasure or on business. The giftor 510 then enters information relating to the giftee 560 such as a name, electronic mailing address and other details they wish to release. It would be evident for example that the giftor 510 may have to provide some information as a default requirement whilst other information is optional and the giftor 510 is told that this allows the credit gifting system 530 to subsequently provide other options to the giftor 510 when they select a gift credit another time or send special offers to the giftee 560.

Once completed the credit gifting system 530 sends an electronic message to the retailer server 540 of the retail chain 550 notifying them that giftor 510 has purchased a gift credit for their store, for giftee 560. The retailer then issues from their retailer server 540 to giftee 560 an electronic message indicating that they have a gift credit for the retailer chain 550 that they may collect and use. This electronic message may for example say “Dear Jane, Knowing your love of makeup Fred thought you might find something here at MAC Essentials for your birthday” wherein “Jane” is associated with the giftee 560, “Fred” with the giftor 510 and “MAC” with retailer chain 550. Associated with the electronic message sent by retailer chain 550 to giftee 560 may be advertising such as for example associated with the retailer chain 550, associated with the wares/services that giftor 510 used in selecting the retailer chain 550, or giftor 560 as they are known to retailer chain 550 in their databases and information is selected based upon their demographic or purchasing history. Optionally this advertising may be specific to one store, e.g. second store 550B, within the chain 550 which is identified as the closest to giftee 560 or has a larger department associated with the wares/services relating to giftee 560.

It would be evident that many options exist to provide the gift credit to the giftee 560. Subsequently the giftee 560 goes to second store 550B of retailer chain 550 in process 570 and obtains the gift credit from the customer service counter on providing valid confirmatory identification. This may for example be in the form determined by the retailer such as a traditional “captive” gift card or another instrument that they wish to employ and provided with an electronic bar code or any other type of secure recognition. For example to increase the giftee 560 view of the process the gift credit may be provided in a manner personalized to them and/or the giftor 510. For example the gift card may be printed at that point with a different message provided by the giftor 510 during purchasing the gift credit, for example “Dear Jane, Happy Birthday Love Fred . . . . See you at the restaurant at 7 pm”. Additionally at this point the retailer chain 550 or second store 550B may provide additional advertising or special offers to the giftor 560 or determine to provide this only after an initial transaction for example. For example, such special offers being associated with the wares/services that giftor 510 used in selecting the retailer chain 550, or giftor 560 as they are known to retailer chain 550 in their databases and information is selected based upon their demographic or purchasing history. Similarly the special offer may to encourage use of the credit gifting system as the retailer chain 550 has found that for every $1 spent from the gift credit the giftor 450 spends another $1 whereas using “captive” gift cards that additional spending is $0.35 for example per $1 on the gift card used. This arising due to the personalized nature of the initial message sent with the gift credit and the message provided when the giftee 560 collects the gift credit. Optionally, the discounts may be provided by the credit gifting system 530 rather than specific retailers as a loyalty bonus for example.

It would be evident to one skilled in the art that rather than the message to the giftee 560 with the gift credit being provided by the retailer server 540 that it may be sent by credit gifting system 530 and a second electronic message is provided to retailer server 540 that notifies the retailer chain 550 of the gift credit for giftee 560. In this manner personal aspects of the message sent to the giftee 560 from the giftor 510 may be separated from the retailer chain 550.

Within the foregoing description of a credit gifting method according to an embodiment of the invention as depicted by schematic 500 it would be apparent to one skilled in the art that in each communication described or implicitly required to perform an action that additional communications between credit gifting system 530, retailer chain 550, giftor 510 and giftee 560 may be provided including but not limited to a receipt indicating the purchase of the gift credit for giftee 560, receipt from retailer chain 540 to credit gifting system 530, and confirmation receipt from credit gifting system 530 to giftor 510 when giftee 560 redeems.

Within the embodiment presented supra in respect of FIG. 5 it was discussed that the advertising provided together with the gift credit may be associated with the second store 550B within the chain 550 that was closest to the giftee 560 based upon the information within the credit gifting system as to the location of giftee 560. However, it would be apparent that this advertising may be dynamically associated with the giftee 560 at the point they receive the gift credit from the giftor 510. This, for example being determined by obtaining from a network a current location, for example by cellular base station triangulation (as used for example in Google® Maps) or alternatively by sending a first message triggering a GPS location return and then sending a second message based upon that GPS location. In general, the former is easier as it does not require the user to authorize providing the GPS location for example.

Now referring to FIG. 6 there is shown a schematic 600 of a credit gifting system 630 according to an embodiment of the invention wherein the giftee 690 is advised of the gift credit based upon information provided by the credit gifting system 630 and can select the store from which to redeem the gift credit. Accordingly as shown a giftor 610 accesses the credit gifting system 630 through a computer network 620, such as the Internet. In doing so they are presented with a series of prompts and requests for information which may be contained within a single web page or a plurality of web pages as would be evident to one skilled in the art. As such the giftor 610 provides information relating to themselves including for example their name, address, age, credit card information or other information relating to a means of paying for the gift credit, i.e. a PayPal™ account and password. At this point the credit gifting system 630 also seeks authorization from the giftor 610 in respect of using the financial instrument, i.e. a credit card such as Visa®, MasterCard®, American Express®, or other financial instruments such as PayPal™, direct bank debit, etc. This authorization also includes approval to purchase the gift credit in whatever currency the gift credit is purchased in. This information may be associated with a user profile created by the giftor at that point in time or previously. They then access the list of member retailers who are part of credit gifting system 630, which may be via one of many methods known to those skilled in the art by selecting a geographic location (e.g. Tampa Bay, Washington, Ottawa, Paris, Berlin etc), an area of interest (i.e. hockey, NASCAR, clothing etc), or a list of retailers that giftor 610 has previously used or prefers.

Having worked through the selection process the giftor 610 has now selected a retailer chain 670, comprising first through third stores 670A through 670C respectively, which meets a predetermined condition in respect of the giftee 690 to whom they wish to send the gift credit. Giftor 610 also designates secondary retailer chains 650 and 660 that provide back-up options to the giftee 690 should there be a problem with retailer chain 670 such as bankruptcy etc. Since the credit gifting system 630 does not transfer funds to retailer chain 670 until the giftee 690 collects the gift credit in process step 680 then should an issue arise the credit gifting system 630 can advise giftee 690 and giftor 610 that an alternative chain is now available to complete the gift credit process through. Such a feature not being possible by gifting “captive” gift-cards. The giftor 510 then enters information relating to the giftee 690 such as a name, electronic mailing address and other details they wish to release.

Once completed the credit gifting system 630 sends an electronic message to the retailer server 640 of the retail chain 670 notifying them that giftor 610 has purchased a gift credit for their store, for giftee 690. The credit gifting system 630 then issues to giftee 690 an electronic message indicating that they have a gift credit for the retailer chain 670 that they may collect and use. This electronic message may for example say “Dear Jane, Knowing your love of good wine Fred thought you might find something here at Merlot for your birthday” wherein “Jane” is associated with the giftee 690, “Fred” with the giftor 510 and “Merlot” with retailer chain 670. Associated with the electronic message sent by credit gifting system 630 to giftee 690 may be advertising such as for example associated with the retailer chain 670, associated with the wares/services that giftor 610 used in selecting the retailer chain 670, or giftor 690 as they are known to retailer chain 670 in their databases and information is selected based upon their demographic or purchasing history. Optionally this advertising may be specific to one store, e.g. second store 670B, within the chain 670 which is identified as the closest to giftee 690 or has a larger department associated with the wares/services relating to giftee 690. Such advertising being extracted for example locally by credit gifting system 630 from data provided by retailer 670 or dynamically from retailer server 640 upon each instance so that advertising information is up-to-date and may be dynamically adjusted by the retail chain 670.

Upon receipt of the electronic message from credit gifting server 630 the giftee 690 may access the credit gifting system 630 or retailer server 640 to retrieve information relating to the stores, i.e. first through third stores 670A through 670C respectively forming part of retail chain 670, to which the gift credit relates. At this point additional advertising may be provided to the giftee 690 either relating to the retailer chain 670 or specific stores, for example second store 670B as it has just received a new delivery of Alsace wines and it is known by retailer server 640 that giftee 690 has bought Alsatian wines previously. At this point the giftee 690 selects second store 670B as the store which to collect their gift credit whereupon they visit second store 670B in process step 680. At this point as outlined supra many options exist to provide the gift credit to the giftee 690 and the giftee 690 may redeem against their desired purchase. Optionally the advertising may be enabled/disabled by the giftee 690 such a through an opt-in/opt-out feature for example.

If an event occurs with retailer chain 670 such as bankruptcy of the entire chain or closure of a predetermined portion of stores within the chain associated with a geographic area that prevents giftee 690 from redeeming their gift credit then giftee 690 can re-access credit gifting system 630 using a hyperlink for example embedded within the original electronic message. Upon entering giftee 690 flags that the second store 690B to which they had the gift credit from giftor 610 is associated with a store that is now closed or associated with a retail chain that is now bankrupt. Upon verification of the identity of giftee 690 and confirmation that the second store 670B has closed or that retailer chain 670 has closed for bankruptcy the credit gifting service 630 provides giftee 690 with details of secondary retailer chains 650 and 660 that were identified by the giftor 610. Giftee 690 can select an alternate retailer chain from the secondary retailer chains 650 and 660 and then proceed to redeem the gift credit.

It would be evident to one skilled in the art that alternate approaches to dealing with the bankruptcy or cessation of business of a retailer. Such approaches include but are not limited to issuing a credit card company insurance that the gift credit is redeemable elsewhere without penalty, issuing a redemption against a credit card owned by the giftee, through refund as a result of insurance with the credit card company, or PayPal™ etc, used to purchase the gift credit, retailer compliance to keep funds associated with gift credit activities within a trust fund not connected with the retailers daily commercial activities.

Within the foregoing description of a credit gifting system according to an embodiment of the invention as depicted by schematic 600 it would be apparent to one skilled in the art that in each communication described or implicitly required to perform an action that additional communications between credit gifting system 630, retailer chain 670, giftor 610 and giftee 690 may be provided including but not limited to a receipt indicating the purchase of the gift credit for giftee 690, receipt from retailer chain 670 to credit gifting system 630, and confirmation receipt from credit gifting system 630 to giftor 610 when giftee 690 redeems.

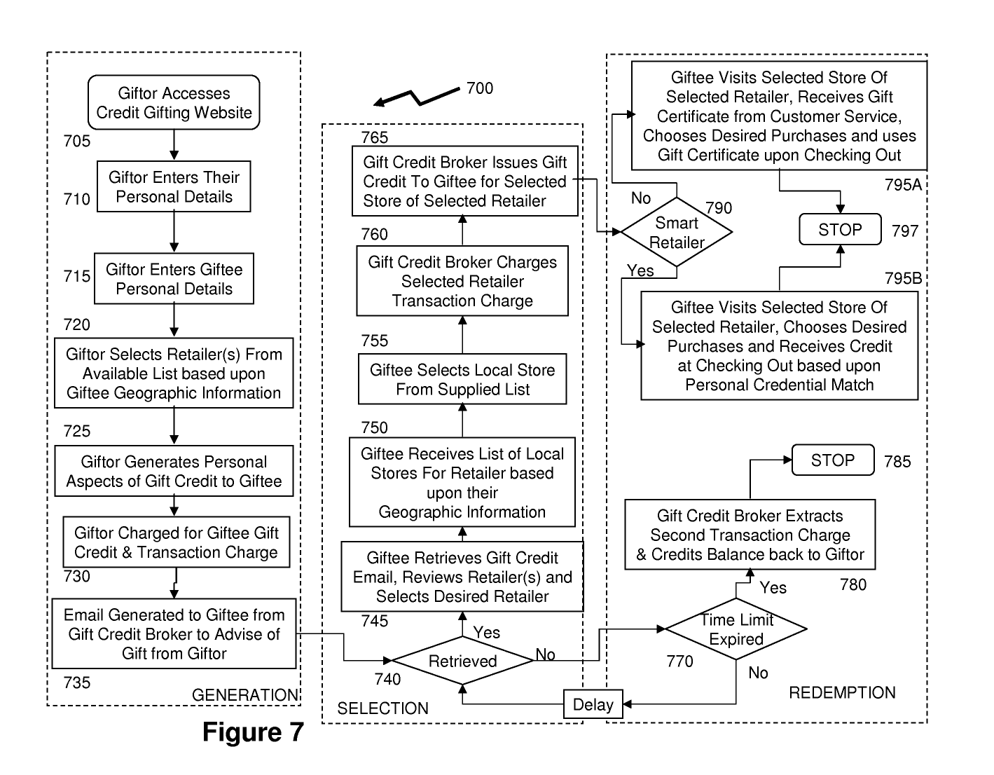

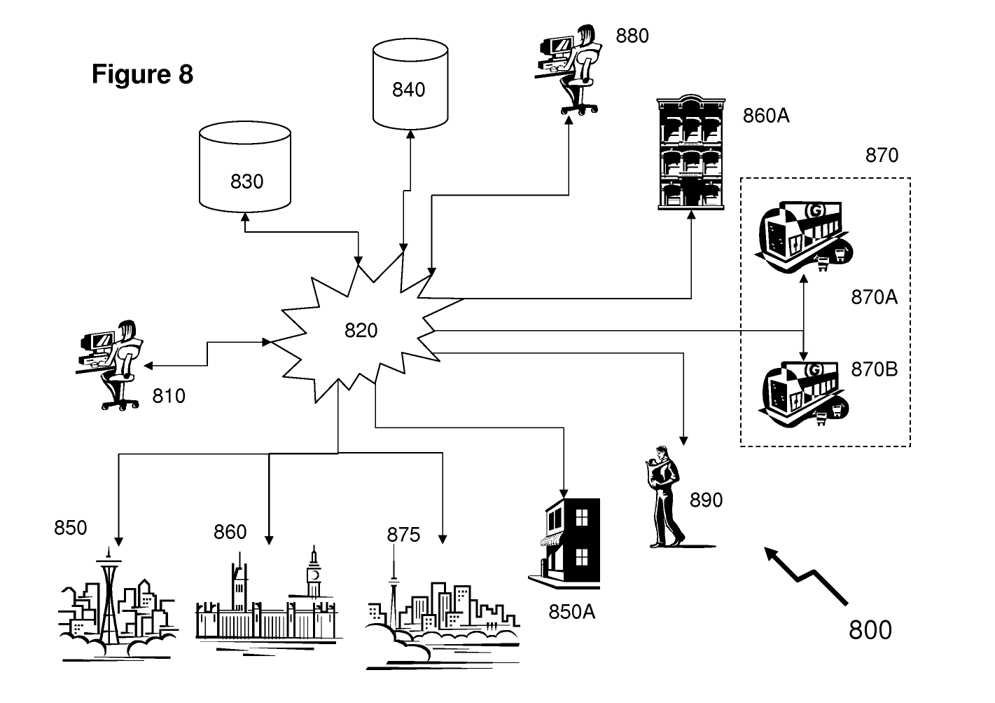

Referring to FIG. 7 there is shown an exemplary flow diagram 700 according to an embodiment of the invention. The process begins at step 705 wherein a giftor accesses the gift credit website and at step 710 enters their personal details followed by the personal details of the giftee at step 715. In step 720 the giftor is presented with a list of retailers based upon the giftee's geographic information and selects the retailer they wish to use for the giftee to redeem their gift at. Next in step 725 the giftor generates personal aspects of the gift credit to the giftee whereupon in step 730 the process progresses to charging the giftor for the value of the gift credit and a service fee. The giftor having previously given authorization for the gift credit and any applicable service fee to be charged to their financial instrument of choice, e.g. credit card. In step 735 the credit gifting system generates an email to the giftee advising them of the gift from the giftor.

Next in step 740 the credit gifting system checks to see if the gift credit has been retrieved by the giftee. If yes then process moves to step 745, but otherwise moves to step 770 wherein the system checks to see if a predetermined time limit has expired. If the time limit has not expired the process cycles back to step 740 with a time delay before it checks again to determine if the gift credit has been retrieved. When the gift credit is retrieved the process moves to step 745 where the giftee reviews the retailers services and/or products and selects the desired retailer to redeem the gift credit from and the process moves to step 750 wherein the giftee is presented with the list of local stores us provided based upon their geographical location and in step 755 the giftee selects the local store they wish to go to. At this point the process moves to step 760 and the selected retailer is automatically charged the retailer service charge associated with the gift credit process before the process moves to step 765 and the credit gifting system issues the final transaction data assigning the gift credit for the giftee to the selected store for the selected retailer.

The process then moves to step 790 wherein the determination is made as to whether the retailer is a “smart” retailer or not. If not then the process moves to step 795A after a notification has been sent to the giftee that the gift credit has been processed and that they should visit the customer service desk at the store they selected. In step 795A the giftee visits the customer service desk and is given a gift card, such as described supra in terms of a personalized gift card, makes the selection of their desired purchase and proceeds to redeem the gift card against this purchase, whereupon the process moves to step 797 and stops.

If the determination in step 790 is that the retailer is a “smart” retailer the process moves to step 795B after a notification has been sent to the giftee that the gift credit has been processed and that they should use a financial instrument identifying themselves to the retailer financial transaction system. Accordingly the giftee visits the retailer, chooses their desired purchase and proceeds to the check-out whereupon when their purchase is processed and payment transaction executes the retailers system acknowledges the gift credit and debits this to the transaction. For example, the financial instrument being a credit card, and again the process moves to step 797 and terminates.

If in step 770 the process determines that the predetermined time limit has elapsed then the process moves to step 780 wherein the credit gifting system extracts a second service charge from the value of the gift credit and credits the balance back to the giftor, whereupon the process moves to step 785 and terminates.

As described supra in respect of FIGS. 3 through 7 the credit gifting system may operate globally allowing for example a giftor in Ottawa, Canada to provide a gift credit to a giftee in Greece, or the giftor in Ottawa, Canada to provide the gift credit for a giftee living in Ottawa but who is going to London, England for a vacation. As such it is possible that the value of the gift credit purchased for the giftee does not entirely cover the cost of the selected item when the giftee redeems the gift credit as prices have been adjusted in the interim. Equally, the price adjustment may have reduced the retail price of the item. It would be evident to one skilled in the art that in instances where the gift credit is very specific that the credit gifting system may not indicate a value and the giftee redeems the gift credit without being aware of this issue. In this scenario retailers within the credit gifting system as part of their membership may warrant to provide specific items at the retail pricing advertised when purchased and over/under pricing variations are an overall aspect of being in business which over time null out. Alternatively the retailer may indicate to the giftor at time of purchase that they warrant the gift credit for up to +10% price variations for example, or some other amount determined by the retailer either territorially, product line based, or specific product based. It would evident that the giftor could provide pre-authorization to charge their financial instrument with another charge based upon the difference between the actual redeemed gift cost and the purchased gift value with such variation limits or that the difference would be born by the giftee.

Now referring to FIG. 8 there is presented a schematic 800 of a credit gifting system 830 according to an embodiment of the invention wherein the giftee 880 is advised of the gift credit based upon information provided by the credit gifting system 830 and can select the retailer chain 870 and first store 870A from which to redeem the gift credit but subsequently decide to re-gift the gift credit as they have not used it. Accordingly as shown a giftor 810 access the credit gifting system 830 via a computer network such as the Internet 820 for example and defines a retailer chain 870 from which giftee 880 can redeem the gift credit. As with the other embodiments presented supra in respect of FIGS. 3 through 6 the process of gifting the gift credit also results in communication with retailer server 840 of the retailer chain 870. Upon receipt of the gift credit the giftee 880 enters the credit gifting system 830 and selects first store 870A from first store 870A and second store 870B to collect the gift credit from.

However, giftee 880 is going to be unable to collect the gift credit due to for example an accident, relocation for work, etc. As such giftee 880 is able to re-enter credit gifting system 830 and notify that she wishes to transfer the gift credit to a third party 890. If at that point giftee 880 indicates that the third party 890 will collect the gift credit at the first store 870A or another store within retailer chain 870 such as second store 870B then the records of the credit gifting system 830 and retailer server 840 are updated and an email sent to third party 890 indicating that giftee 880 has requested they go to a store within retailer chain 870 and redeem the gift credit on their behalf. Third party 890 when receiving the notification is able to select either first store 870A or second store 870B to redeem the gift credit at.

If, however, third party 890 is resident in another city, country and accordingly unable to redeem the gift credit at first store 870A, second store 870B or any store associated with retailer chain 870 then giftee 880 is provided with alternate retailers providing comparable goods/services to that employed by the giftor 810 in creating the gift credit, such as for example stores “Nordstrom” 850A in Seattle 850 and “Harrods” 860A in London 860 rather than “Holt Renfrew” in Toronto 875 where retailer chain 870 (“Holt Renfrew”) was located. Once giftor 880 selects for example “Nordstrom” 850A in Seattle 850 the credit gifting system communicates with the retailer server 840 to cancel the gift credit, the servers of “Nordstrom” 850, not shown for clarity, and third party 890. It would be apparent to one skilled in the art that the credit gifting system 830 may request a service fee from giftee 880 for moving the gift credit to another retailer and that this service fee may be different if the retailer is within the same city but different if the retailer is in a different city, country etc. Optionally the credit gifting system 830 may waive the service fee if desired or if the third party 890 is still going to redeem the gift credit at the original first store 870A.

It would be evident to one skilled in the art that the transfer of the gift credit may alternatively be simply on the basis that the giftee does not wish to receive the gift and hence redirects the gift to another.

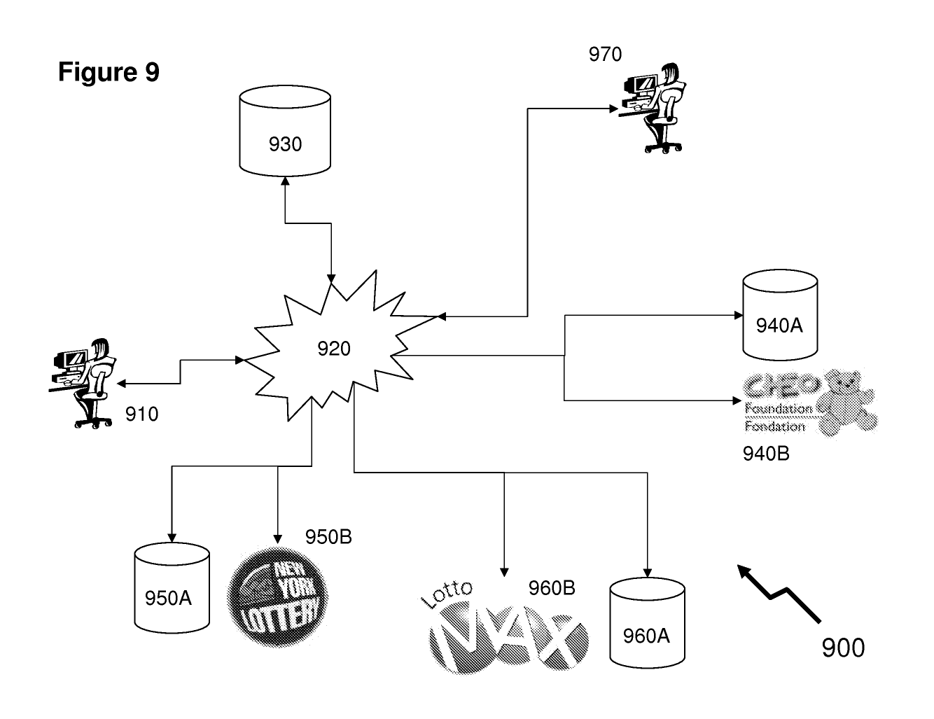

Now referring to FIG. 9 there is shown a credit gifting system 900 according to an embodiment of the invention wherein a giftor 910 accesses a credit gifting system 930 via a computer network 920 such as the Internet. Now in contrast to embodiments described supra in respect of FIGS. 3 through 8 the giftor 910 decides that they would like to purchase a ticket for a licensed lottery or raffle for the giftee 970. Amongst the licensed lotteries and raffles supported by credit gifting system 930 are “New York State Lottery” 950B, “Lotto MAX” 960B, and “CHEO Lottery” 970B. Credit gifting system 930 accessing first through third servers 950A, 960A and 970B for these lotteries respectively. In this instance giftor 910 chooses to purchase from “New York State Lottery” 950B as giftee 970 is a resident of Rochester, N.Y., USA. As such the credit gifting system 930 engages with first server 950A to process the gift credit and is provided with two options, a credit or a pick. Lottery tickets may be referred to by some as raffle tickets.

In the first instance, credit, the giftor 910 would provide giftee 970 with a gift credit redeemable at an outlet providing the “New York Lottery” 950B for them to purchase a lottery ticket. In the second instance, pick, the first server 950A provides back through credit gifting system 930 and the computer network 920 to the giftor 910 a selection of lotteries, including “New York's MEGA MILLIONS”, “New York POWERBALL”, “Sweet Millions’ and “New York Lotto”, which have not been shown for clarity. The giftor 910 is then able to select a lottery, for example “Sweet Millions” and purchase the value of lottery entries they wish and may elect to provide a date in the future for which the lottery would be run. In this manner the giftor 910 can gift to the giftee 970 lottery tickets to an event occurring in the future which may be one wherein they are provided a “quick pick” of selected numbers or simply an entry into the lottery. It would be apparent to one skilled in the art that in this embodiment the giftor 910 purchasing for a licensed lottery, registered charity, or raffle in committing to the purchase also agrees that the ticket purchased is in the name of the giftee 970 thereby avoiding issues wherein the gifted ticket is a substantial winner and avoiding litigation, acrimony etc.

It would be apparent to one skilled in the art that variants of the above described embodiments can be considered that do not depart from the spirit of the invention nor change the object of the invention. Within the embodiments described supra there has been outlined a method and system related to “virtual” gift giving by a third party (the giftor such as giftor 510 in FIG. 5 or giftor 610 in FIG. 6 for example) who purchases a “gift credit” for a gift in lieu of the gift itself for another (the giftee such as giftee 560 in FIG. 5 and giftee 690 in FIG. 6 for example). The gift credit purchase may be made electronically by methods including but not limited to credit card, debit card, electronic funds transfer, and PayPal™. This method of gift giving may be specifically described as a “credit gifting” or “gift crediting” method based upon a system provided by a gift credit provider through a computer network, such as the Internet for example. Credit gifting is the transaction that occurs when one party (‘grantor’) electronically purchases a ‘virtual’gift in the form of a monetary credit to be used by the second party (“giftee”) to buy a Gift which is obtained from a retailer forming part of the approved retailer list of the credit gifting system and may be redeemed for either a service or product.

Within the embodiments described supra it may be assumed by one reading the descriptions in respect of FIGS. 3 through 9 that the transaction is executed in a single currency. However, the credit purchased can be issued in any currency or denomination for use by the second party (“giftee”) which would be determined by the credit gifting system in dependence upon factors such as the geographic location of the giftee and the geographic location of the retailer store or retailer chain selected by the giftor/giftee. The giftor would be debited in their local currency determined for example upon factors such as their geographic location and the financial instrument employed in the gift credit purchase. It would be apparent to one skilled in the art that some retailers are global in their enterprises and that where these are “smart” as discussed supra in allowing the gift credit to be processed at the point of sale without prior engagement with the giftee may only be determined in currency of transaction at that instant of the point of sale, for example a gift credit for Tommy Hilfiger™ might be redeemed as easily in Tokyo or Paris as New York, Los Angeles and Ottawa.

The gift credit transaction is handled through an enterprise (hereinafter “Company”) which may be part of an existing financial or retail organization or a discrete entity and provides the credit gifting system to consumers and retailers through online portals and the Company web site for example. For example retailers and existing registered giftors may exploit different online portals to the general Company web site. The specific software system application developed to purchase a credit for a gift is called a “credit gifting system” whereby the “credit gifting system” provides a secure electronic commerce environment allowing the giftor to authorize the credit gifting system to use the grantor's credit, debit card, or other monetary credit form to reserve essentially a “gift credit” in favor of a named “recipient” (giftee) with the identified retailer which may be further defined to a particular store within the chain of the retailer or the stores with a geographic region around the giftor's geographic location for example. Alternatively, the giftee can provide the gift for a location not associated with the giftor, such as a planned vacation or business destination.

Furthermore, the grantor (giftor) authorizes the Company to use the grantors credit card, debit card, etc to automatically deduct an agreed to “convenience fee/service fee” payable to the Company for the grantors use of the “credit gifting system” and the flexibility, personalization, etc it provides compared with “captive” gift cards or other pre-paid gift cards.

Whereas the Company charges the ‘gift grantor’ a convenience fee for use of the electronic commerce based credit gifting system; all retailers accepted as official Company Retail Merchants are also automatically charged a “service charge/service fee” when either the gift credit is transferred financially into their systems or the giftor redeems the gift credit. This retailer fee being associated with the retailer being listed as an approved retailer allowing a “grantor” to select them and also in respect of providing them associated with the gift credit processed additional demographic/personal information so that the retailer may improve their indirect and direct marketing activities. Optionally this service fee may be tiered according to whether the gift recipient (giftee) receives notification of the gift credit from the giftor, Company, or the retailer. The Company may also support multiple portals, including for example “GiftCredit.com”, “CreditGifting.com”, “GiftCredit.ca”, “GiftCredit.mobi”, and “GiftCredit.org”, so that retailers have additional information such as whether these purchases are being made by individuals on the home computer, by individuals on their mobile devices, by organizations (i.e. employee rewards), etc. As outlined supra in respect of FIG. 9 the credit gifting system application may also be used by individuals or corporations to electronically purchase a charity ticket or optionally make a donation to a charity.

As presented supra the giftor accesses the credit gifting system web site; reviews the Company provided list of merchants and merchant products and services. Grantor then authorizes the Company to use grantor credit or debit card to securely purchase a “gift credit” on behalf of the giftor for the named recipient from anywhere in the world, at any time of day; in an currency or monetary denomination. The credit gifting system may be accessed using one or more forms of communication including the Internet, LAN, WAN, etc through wireless, coaxial cable, or wired services through a plurality of service provides from a variety of user devices including but not limited to iPod, IPad, cellular telephones, telephones, personal computers, gaming consoles, personal digital assistants, notebook computers, tablet PCs, sales kiosks, etc. Access to the credit gifting system may be directly through the credit gifting system or by applications embedded into either electronic equipment such as mobile devices for example or applications such as social media including but not limited to FaceBook™, Twitter and LinkedIn™. Equally the credit gifting system may be added as an element within a web browser such as and not limited to Google™ or Yahoo™ for example.

The embedding of the credit gifting system method into such software, applications, and browsers allows for example the giftor when browsing to rapidly select an item and rather than searching as to where to obtain it simply link through the credit gifting system interface and the knowledge base of the web browser provider to select the retailer automatically and then proceed to sending the gift credit to the giftee. Further whilst the embodiments presented supra have been presented with the user redeeming the gift credit for an item they select from a retailer identified by the giftor it may be evident to one skilled in the art that the system can be made more specific to limiting the gift credit to a particular form of wares, such as kitchenware, sports equipment, clothing etc, be limited to a manufacturer, e.g. Nike™, Burberry™, KitchenAid™, a particular product, e.g. a tennis racket, a coat, a saucepan, or a specific item, e.g. Burberry washed leather jacket, Nike AW77 jacket, All Clad Cop•R•Chef allowing the giftee to select their size without embarrassment etc as the giftee does not need to know the giftor's current personal physical dimensions etc.

It would be apparent to one skilled in the art that the crediting gifting system as proposed may also be provided at free standing or portable electronic kiosks which for example may be placed at shopping malls, within department stores, retail stores, catalog shops etc. It would also be apparent that the credit gifting system approach may form the basis of a gift registry for a wedding, wedding anniversary, birthday etc. In this the giftee may enter the credit gifting system and create a list of desired items, e.g. bakeware, bed linens, cutlery etc and send those invited to attend the event a link to the credit gifting system repository. Then a giftor in logging into the credit gifting system and entering the giftee's details would be directed to a list of items the giftee would like to receive and therefrom the giftor may select the retail chain, store etc at which a gift credit for the giftee is provided. In this manner a bridal registry for example does not have to be limited to one store providing all the items but is now hosted essentially through the credit gifting system.

In addition to the features and functions described above in respect of FIGS. 3 through 9 it would be evident to one skilled in the art that the financial aspects of the transaction may include, but not be limited to, currency conversion, applying state/national international/country and provincial taxes, and insurance.

It would also be apparent to one skilled in the art that where the gift credit is delivered to a giftee through a format geared to mobile devices, e.g. text, or that the user is accessing the gift credit through a mobile device that the retailer information may be dynamically allocated based upon the location of the giftee at that point. In this manner for example, a giftor may gift a giftee a present on their birthday and the giftee may redeem this based upon their current location rather than their home address as provided to the credit gifting system by the giftee. Additionally it would be evident that where the gift credit relates to a plurality of retail locations and a plurality of retailers that the process may be extended to provide a selection feature wherein the credit gifting system is notified of the location of the giftee, associates that with a particular retailer and/or retail location and transmits to the giftee and/or retailer a second notification that is modified to be compatible with the systems of the retailer selected.

It would also be apparent to one skilled in the art that the gift credit may be redeemed electronically by the giftee rather than them physically visiting a retailer location etc. For example if the gift credit was provided for an online retailer such as Amazon® the giftee may for example enter a unique identifier provided within the message from the giftor or credit gifting system into the online purchasing system of the online retailer through either a field such as “Promotion Code” which many online purchasing portals have as a standard feature or through entering this unique identifier in another field of the online form for purchasing. The retailer e-commerce system would then recognize this unique identifier as referring to a credit existing with the retailer through the credit gifting system. Equally the giftee may elect to order from the online purchasing system provided by the retailer that the giftor selected for a variety of reasons including ease of purchasing without visiting the store, delivery of the purchased items, and online pricing being lower than that in the retail outlet. Accordingly the gift credit may not only be provided electronically to the giftee but may be redeemed electronically by the giftee.

It is anticipated that the Company would execute sales representation agreements with every participating merchant. The Merchant acknowledges that the Company has the right to advertise wares/services etc relating to the merchant and charge the merchant multiple fees, for example a yearly fee as a ‘listing’ fee for Merchant/Retailer's representation on the Company web site, and additional fees for acknowledging the payment of a mutually agreed upon service charge for each fully transacted purchase of ‘store’ credit at the time grantor credit/debit card is processed. It would be apparent that some fees may be fixed and others variable in dependence upon the value of transactions or an accumulated revenue stream within that year. The Company further anticipates directly connecting the Company web site to that of the Merchant's allowing selection of retail outlets, merchandise, services etc.

It would also be anticipated, and apparent to one skilled in the art, that the gift crediting system would be interfaced to the Merchant's financial systems so that redemption of the gift credit as recognized and processed by the Merchant's financial systems is communicated to the gift credit system allowing the process to be completed and closed. Such closure for example including notification to the giftor that the gift credit has been redeemed, clearing the pending transaction from the gift credit system, and updating giftor and/or giftee profiles.

Whilst the particular embodiments described supra in respect of the credit gifting system have been presented and discussed in respect of retailers and giftors purchasing through financial transactions. However, it would be apparent to one skilled in the art that major banks or financial institutions, such as MasterCard®, Capital One® Morgan Bank for example, may issue financial cards that allows the card user to acquire points, much like they would with AirMiles®, which are then redeemable through the credit gifting system for the purchase of gifts or alternatively gifts purchased within the credit gifting system trigger points accumulation in other programs such as AirMiles®.

It would also be apparent to one skilled in the art that the organization managing the gift crediting system may establish its own instruments including but not limited to a credit card or a loyalty card. The loyalty card for example providing a discount or bonus when the giftor has used it a number of times exceeding a predetermined threshold or value of gifts. The discount/bonus being offered for example in escalating manner with increasing usage thresholds. The credit card may for example be a card branded for the gift crediting system organization by a credit provider such as MBNA®, MasterCard® or through a bank such as Bank of America, HSBC, etc.

It would also be anticipated that the giftor using the credit gifting system would have rewards associated with at least one of the financial instrument that they use to pay for the gift credit to the giftee or rewards associated with either another program. Examples of other programs may be those run by their bank, credit card provider, independent programs such as AirMiles®, and even the retailer they are selecting to purchase the gift credit with and with whom they have an account collecting reward points. Whilst these programs may use different terms for the rewards or bonuses given within this specification for simplicity we will refer to them as “reward points”.

In the situation that the giftor has an account with the retailer then they may earn additional reward points from this purchase or elect to transfer reward points given by the credit gifting system to their account with the retailer. Equally the giftor may elect to redeem reward points with the retailer as a way of increasing the gift credit value or reducing their immediate expenditure in purchasing the gift credit. In another situation the giftor may elect to donate reward points, for example those resulting from the gift credit purchase or a portion of others that they have to a charity as part of the overall process they engage in the purchasing of the gift credit. Likewise a giftee in accessing the credit gifting system to redeem a gift credit may be similarly invited to donate reward points to a charity or charities. Similarly a giftee wherein they have the option of selecting to redeem the gift from multiple retailers may be incented by one or more of these retailers with the offer of reward points to the giftee and/or the giftor or a charity.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a database accessible to users of a computer network, the database comprising a plurality of first entries each relating to a provider, a plurality of second entries each relating to at least one of a product and a service provided by a provider, a plurality of third entries each relating to a first user wishing to provide credit in order to give a gift, and a plurality of fourth entries each relating to a second user for whom a gift is requested;
receiving from a first user first data, the first data comprising a first data portion relating to an aspect of the first user, a second data portion relating to an aspect of an intended recipient, and a third data portion relating to at least one of a first entry and a second entry selected by the first user from the respective pluralities of first entries and second entries within the database;
receiving from the first user second data relating to a financial instrument;
charging against the financial instrument a charge determined in dependence upon at least one of the second entry wherein the third data portion contains the second entry and a financial value determined by the user; and
upon verifying that the charge against the financial instrument has been accepted at least one of:
sending to the recipient a first indication that a gift credit has been made, the first indication comprising at least one the aspect of the first user, the aspect of the intended recipient, the financial value, the first entry within the third data portion, the second entry within the third data portion, and redeem information relating to at least one of the first entry and second entry selected by the first user; and
sending to the provider relating to the first entry selected by the first user a second indication that a gift credit has been made, the second indication comprising at least one the aspect of the first user, an aspect of the intended recipient, the financial value, the first entry within the third data portion, the second entry within the third data portion, and redeem information relating to at least one of the first entry and second entry selected by the first user.

2. A method according to claim 1 further comprising;
providing with the first indication a downloadable voucher or some type of gift claim compatible with a computer system of the provider associated with the first entry and associating the downloadable voucher to the second indication.

3. A method according to claim 2 wherein,
the downloadable voucher comprises at least one of a one dimensional bar code, a two dimensional bar code, an alphanumeric string, an encrypted alphanumeric string, and an encoded bar code.

4. A method according to claim 1 wherein,
providing the first indication further comprises providing a credential to the recipient allowing them to access the database and at least one of change the selection of the first entry to another first entry for the same provider, change the selection of the second entry to another second entry for the same first entry, and change the fourth entry within the database associated with the first indication to allow another user to redeem the gift credit on their behalf.

5. A method according to claim 1 further comprising;
at least one of charging the giftor a convenience fee and charging the provider a service fee wherein the at least one of is determined in dependence upon at least one of the financial value, a predetermined value, and the provider.

6. A method comprising:
providing a registry accessible to a giftor via a global computer network and comprising:
a first entry of a plurality of first entries, each first entry relating to at least one of a service provider and a retailer;
a second entry of a plurality of second entries, each second entry relating to a location of the first entry;
a third entry of a plurality of second entries, each third entry relating to at least one of a service provided by the service provider and a category of wares offered for sale by the retailer;
a fourth entry of a plurality of fourth entries, each fourth entry relating to a third entry of the plurality of third entries and being at least one of an aspect of the service associated with the third entry and a product associated with the category of ware associated with the third entry;
providing an order interface accessible to the giftor via the global computer network and allowing the giftor to create a gift credit by:
selecting at least one of a predetermined portion of the plurality of first entries and a predetermined subset of the plurality of second entries;
selecting at least one of a predetermined portion of the plurality of third entries and a predetermined subset of the plurality of fourth entries;
providing at least an aspect of the giftee to whom the gift credit is to be provided and an electronic address associated with the giftee;
providing a financial value associated with the gift credit and a financial instrument against which the financial value may be charged;
providing authorization data relating to the financial instrument to charge both the financial value and a convenience fee against said financial instrument;
providing a charging interface for interfacing to a server associated with the financial instrument to process the charge against the financial instrument and receiving an authorization code or a refusal; and
providing a notification interface for sending when an authorization code is received a notification, the notification being sent to the electronic address of the giftor and indicating that a gift credit has been purchased for the giftor by the giftee.

7. A method according to claim 6 wherein,
the notification to the giftor comprises:
first content relating to the at least one of the predetermined portion of the plurality of first entries and the predetermined subset of the plurality of second entries;
second content relating to the at least one of the predetermined portion of the plurality of third entries and the predetermined subset of the plurality of fourth entries; and
third content relating to a financial transaction system associated with the one of the at least one of the predetermined portion of the plurality of first entries and the predetermined subset of the plurality of second entries.

8. The method according to claim 7 wherein,
the third content allows the giftor to purchase an item directly from the at least one of the predetermined portion of the plurality of first entries and the predetermined subset of the plurality of second entries, the item being at least of within the at least one of the predetermined portion of the plurality of third entries and the predetermined subset of the plurality of fourth entries.

9. The method according to claim 8 wherein,
purchasing the item directly comprises at least one of:
presenting a printed copy of the notification at a point of sale terminal;
scanning a printed copy of the notification at a point of sale terminal;
scanning a first predetermined portion of the notification on a wireless device associated with the giftee at a point of sale terminal; and
transmitting a second predetermined portion of the notification from a wireless device associated with the giftee to a point of sale terminal.

10. A method according to claim 6 further comprising;
providing a first recipient interface for receiving from the giftee an indication of their location and associating that location with a second entry, the second entry being either associated with the at least one of the predetermined portion of the plurality of first entries or part of the predetermined subset of the plurality of second entries; and
transmitting to the giftee a subsequent notification, the second notification relating to the second entry associated with the giftee location.

11. A method according to claim 10 further comprising;
transmitting to the retailer of which the second entry associated with the giftee location forms part a third notification, the third notification relating to a permission for the giftee to redeem the gift credit.

12. A method according to claim 6 further comprising;
providing a second recipient interface for receiving from the giftee an indication of at least one of:
a giftee generated variation to the selected at least one of the predetermined portion of the plurality of first entries and the predetermined subset of the plurality of second entries;
a giftee generated variation to the selected at least one of the predetermined portion of the plurality of third entries and the predetermined subset of the plurality of fourth entries;
receiving from the giftee at the second recipient interface an aspect of a nominee to whom the gift credit shall be retransmitted and an electronic address associated with the nominee; and
transmitting to the electronic address associated with the nominee a second notification indicating that a gift credit has been purchased for the giftor by the giftee and that the giftee wishes the nominee to redeem the gift credit on their behalf.

13. A method according to claim 12 wherein,
the second notification comprises:
first content relating to a selection by the giftee from the at least one of the predetermined portion of the plurality of first entries and the predetermined subset of the plurality of second entries;
second content relating to a selection by the giftee from the at least one of the predetermined portion of the plurality of third entries and the predetermined subset of the plurality of fourth entries; and
third content relating to a financial transaction system associated with the one of the at least one of the predetermined portion of the plurality of first entries and the predetermined subset of the plurality of second entries.

14. A method comprising:
receiving at a master transaction system associated with an enterprise a first notification via a global computer network from a gift credit system that a gift credit has been issued to a giftee, the first notification comprising;
a first entry of a plurality of first entries, each first entry relating to a location of the enterprise;
a second entry of a plurality of second entries, each second entry relating to at least one of a service provided by the enterprise, a category of wares offered for sale by the enterprise, an aspect of a service provided by the enterprise, and a product offered for sale at the location identified by the first entry;
a first financial value associated with the gift credit;
a first transaction identifier provided by the gift credit system and uniquely identifying the gift credit;
transmitting from the master transaction system to a client transaction system associated with the first entry within the first notification a second notification comprising at least:
the second entry of a plurality of second entries, each second entry relating to at least one of a service provided by the enterprise, a category of wares offered for sale by the enterprise, an aspect of a service provided by the enterprise, and a product offered for sale at the location identified by the first entry;
a second financial value associated with the gift credit;
a second transaction identifier provided by the master transaction system; and
an authorization identifier for storage by the client transaction system authorizing processing of the gift credit upon its presentation to the client transaction system wherein presentation is made in respect of the at least one of the service and wares defined by the second entry.

15. A method according to claim 14 wherein,
the first notification further comprises at least one of:
an aspect of the giftee to whom the gift credit is to be provided;
an electronic address associated with the giftee;
an aspect of the giftor who generated the gift credit;
an electronic address associated with the giftor;
an indication of an expiration date for redemption of the gift credit; and
an authorization number associated with the gift credit system.

16. A method according to claim 15 wherein,
the authorization number permits the master transaction system to trigger a financial transfer from the gift credit system to the enterprise associated with the master transaction system,
wherein sufficient funds for the financial transfer having been previously transferred to the gift credit system during placement of the order for the gift credit.

17. A method according to claim 14 wherein,
the first financial value is equal to the value of the gift credit purchased minus a first predetermined amount; and
the second financial value is equal to the first financial value minus a second predetermined amount.

18. A method according to claim 17 wherein,
the first and second predetermined amounts are determined in dependence upon at least one of value of the purchased gift credit, the enterprise, the first entry, an aspect of the giftee, an aspect of the giftor, an aspect of the credit gifting system, a promotional code employed by the giftor when making the gift credit purchase, the date of the gift credit purchase, and the time of the gift credit purchase.

19. A method according to claim 14 further comprising;
transmitting to the giftee a third notification comprising:
first content relating to the at least one of the predetermined portion of the plurality of
first entries and the predetermined subset of the plurality of second entries;
second content relating to the at least one of the predetermined portion of the plurality of third entries and the predetermined subset of the plurality of fourth entries;
third content relating to the giftee purchasing the gift credit;
fourth content relating to the financial value of the gift credit;
fifth content for processing by the client transaction system and associating the authorization identifier with the redemption by the giftor.

20. A method according to claim 15 wherein,
the fifth content is provided as at least one of a one dimensional bar code, a two dimensional bar code, an alphanumeric string, an encrypted alphanumeric string, and an encoded bar code.
